(19) United States
(12) Patent Application Publication
(10) Pub. No.: US 2015/0260850 A1
(43) Pub. Date: Sep. 17, 2015

(54) METHOD AND APPARATUS FOR GEO-FENCE DETECTION

(71) Applicant: MARVELL WORLD TRADE LTD, St. Michael (BB)

(72) Inventors: Jiangping DENG, Shanghai (CN); Zhike JIA, Fremont, CA (US); Jian CHENG, Guangzhou (CN); Qiufang ZHU, Shanghai (CN); Yongsong WANG, Shanghai (CN); Peng ZHANG, Shanghai (CN)

(73) Assignee: MARVELL WORLD TRADE LTD, St. Michael (BB)

(21) Appl. No.: 14/643,670

(22) Filed: Mar. 10, 2015

Related U.S. Application Data
(60) Provisional application No. 61/951,769, filed on Mar. 12, 2014.

(51) Int. Cl. G01S 19/42

(52) U.S. Cl. CPC G01S 19/42

(57) ABSTRACT

Aspects of the disclosure provide an apparatus that includes a navigation signal receiver. The navigation signal receiver includes a receiving circuit configured to receive a satellite navigation signal from a satellite and a processing circuit configured to calculate a distance between the apparatus and the satellite based on the satellite navigation signal, and determine whether the apparatus is in a detection area based on the distance, a minimum distance from the detection area to the satellite and a maximum distance from the detection area to the satellite.

### INCORPORATION BY REFERENCE

This present disclosure claims the benefit of U.S. Provisional Application No. 61/951,769, “Geofencing Detection Method Based on Global Navigation Satellite System” filed on Mar. 12, 2014, which is incorporated herein by reference in its entirety.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

A geo-fence is a virtual perimeter for a real-world geographic area. The geo-fence can be used by location-aware devices to detect whether the location-aware devices enter or exit the geographic area. In an example, a location-aware device detects present location information of the device, such as latitude, longitude, altitude and the like of the device, compares the present location information with a geo-fence for a geographic area to determine whether the location-aware device is inside the geo-fence or outside geo-fence.

### SUMMARY

Aspects of the disclosure provide an apparatus that includes a navigation signal receiver. The navigation signal receiver includes a receiving circuit configured to receive a satellite navigation signal from a satellite and a processing circuit configured to calculate a distance between the apparatus and the satellite based on the satellite navigation signal, and determine whether the apparatus is in a detection area based on the distance, a minimum distance from the detection area to the satellite and a maximum distance from the detection area to the satellite.

In an embodiment, the detection area is a circular detection area.

According to an aspect of the disclosure, the processing circuit is configured to adjust the minimum distance at a time based on a first distance between the satellite and a first location in the detection area at a previous time, a first speed of change for the first distance at the previous time and a first acceleration of change for the first distance at the previous time, and adjust the maximum distance at the time based on a second distance between the satellite and a second location in the detection area at the previous time, a second speed of change for the second distance at the previous time and a second acceleration of change for the second distance at the previous time.

In an embodiment, the apparatus includes a processor configured to perform position, velocity and time (PVT) computation to calculate the first distance, the first speed, the first acceleration, the second distance, the second speed and the second acceleration. In an example, the processing circuit is configured to detect an event that the circuit enters/exits the detection area and the processor is configured to calculate a location of the apparatus to confirm or deny the event.

Further, according to an aspect of the disclosure, the receiving circuit is configured to receive satellite navigation signals from a plurality of satellites. The processing circuit is configured to calculate an overlap of clock bias and/or an overlap of clock drift that is a function of distances between the circuit and the plurality of satellites, minimum distances from the detection area to the plurality of satellites and maximum distances from the detection area to the plurality of satellite, and determine whether the circuit is inside the detection area based on the overlap of clock bias and/or the overlap of clock drift.

Aspect of the disclosure provide a method for geo-fence detection. The method includes receiving, at a circuit, a satellite navigation signal from a satellite, calculating a distance between the circuit and the satellite based on the satellite navigation signal, and determining whether the circuit is in a detection area based on the distance, a minimum distance from the detection area to the satellite and a maximum distance from the detection area to the satellite.

Aspects of the discloser provide a circuit for geo-fence detection. The circuit includes a receiving circuit configured to receive a satellite navigation signal from a satellite and a processing circuit configured to calculate a distance between the circuit and the satellite based on the satellite navigation signal, and determine whether the circuit is in a detection area based on the distance, a minimum distance from the detection area to the satellite and a maximum distance from the detection area to the satellite.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows a block diagram of an electronic device 100 according to an embodiment of the disclosure;

FIG. 2 shows a plot 200 for illustrating geo-fence detection according to an embodiment of the disclosure;

FIG. 3 shows a flow chart outlining a process 300 according to an embodiment of the disclosure;

FIG. 4 shows a flow chart outlining a process 400 according to an embodiment of the disclosure; and

FIG. 5 shows a plot 500 for determining a detection area according to an embodiment of the disclosure.

### DETAILED DESCRIPTION OF EMBODIMENTS

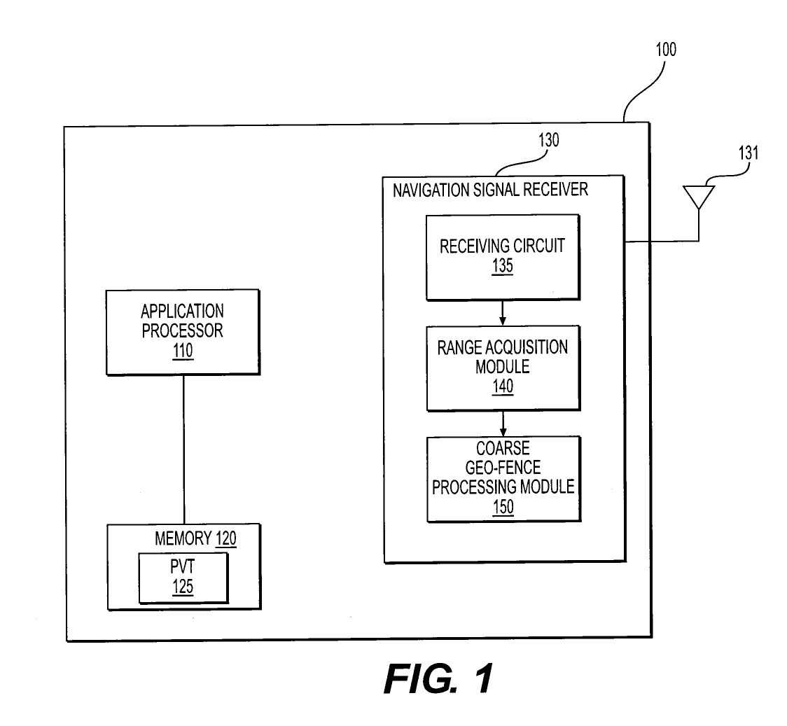

FIG. 1 shows a block diagram of an electronic device 100 according to an embodiment of the disclosure. The electronic device 100 includes a navigation signal receiver 130 configured to receive and process signals from a satellite navigation system. Further, the navigation signal receiver 110 is configured to perform a geo-fence detection, such as a coarse geo-fence detection, that does not require location computation.

The electronic device 100 can be any suitable device, such as a tablet computer, a smart phone, a camera, a wearable device, and the like. The electronic device 100 is configured to execute an application that requires geo-fence detection. Generally, a geo-fence is a virtual perimeter for a real-world geographic area, and the geo-fence detection compares location information of a device with the geo-fence to determine whether the device is inside the geo-fence or outside the geo-fence.

In an example, the electronic device 100 is a smart phone 100 belonging to a user who has subscribed an information service from a business owner. The smart phone 100 executes a mobile application, for example provided by the business owner. The mobile application includes a geo-fence defined around a geographic area, such as a business location of the business owner and the like, and the smart phone 100 executes the mobile application to perform geo-fence detection periodically, such as once per second and the like, to detect a geo-fence event, such as entering the geo-fence, exiting the geo-fence. When the user with the smart phone 100 enters or exits the geographic area, the smart phone 100 detects the geo-fence event, and informs a server (not shown) that provides the information service. In an example, the server provides a push notification to the smart phone 100 in response to the geo-fence event.

In another example, the electronic device 100 is a wearable device 100 that can be attached to a child. In an embodiment, the wearable device 100 executes an application having a geo-fence defined around a geographic area, such as a day care center, and the like, and the wearable device 100 performs geo-fence detection periodically, such as five time per second, and the like, to detect a geo-fence event, such as exiting the day care center. In an example, when a child is dropped off at the day care center, the wearable device 100 is attached to the child and is activated. When the child exits the day care center by accident in an example, the wearable device 100 detects the geo-fence event, and operates in response to the geo-fence event. In an example, the wearable device 100 sends out audio alarm. In another example, the wearable device 100 transmits wireless signals that can generate alarm signals, for example, on a monitoring device of the day care center and/or a mobile device with the child's parent.

Location information can be detected from various sources, such as from a satellite navigation system, a cellular network, a Wi-Fi network, and the like. In the FIG. 1 example, the navigation signal receiver 110 is able to receive and process satellite navigation signals, and location information can be calculated from the satellite navigation signals.

In an example, satellite navigation based location calculation relies on position, velocity and time (PVT) calculation, and requires significant amount of computation resource. In an example, the PVT calculation uses a recursive algorithm that requires certain computation resource, such as a processing speed, a cache speed, a cache size, and the like. According to an aspect of the disclosure, the navigation signal receiver 130 is implemented with a relatively low cost and does not have enough computation resource, such as not enough processing speed, not enough cache speed, not enough cache size, and the like, to perform the PVT calculation.

In an embodiment, the electronic device 100 includes another circuit with enough computation resource for PVT calculation. In the FIG. 1 example, the electronic device 100 includes an application processor 110 having the computation resource for PVT calculation. The application processor 110 is configured to be able to execute various applications. The electronic device 100 includes a memory 120 storing software instructions of applications, and the application processor 110 can executes the software instructions to run the applications on the electronic device 100. In the FIG. 1 example, the memory 120 stores software instructions 125 for PVT calculation. The application processor 110 can execute the software instructions 125 to receive information from the navigation signal receiver 130, calculate position, velocity and time, determine the location of the electronic device 100, and can perform location based applications.

In an embodiment, the electronic device 100 is a battery-powered device. In order to save power, the application processor 110 is configured to have an active mode and a power saving mode. In the active mode, the application processor 110 is able to execute software instructions. When the application processor 110 is idle, the application processor 110 enters the power saving mode to save power.

According to an aspect of the disclosure, the electronic device 100 is configured to execute a geo-fence based application that requires geo-fence detection regularly, such as at a frequency of one or more times per second and the like. In the electronic device 100, the navigation signal receiver 130 receives the satellite navigation signals, processes the satellite navigation signals and performs a coarse geo-fence detection without location computation at the frequency. In an example, the coarse geo-fence detection without location computation has a lower accuracy compared to a geo-fence detection that is based on PVT computation. When the navigation signal receiver 130 detects a geo-fence event in the coarse geo-fence detection, the navigation signal receiver 130 signals the application processor 130, and the application processor 130 performs a geo-fence detection that is based on PVT computation to confirm or deny the geo-fence event. Thus, the application processor 130 performs the PVT based geo-fence detection at a reduced frequency, such as once per minute, and the like. Thus, the application processor 130 has more idle time and is more likely to enter the power saving mode to save power.

In the FIG. 1 example, the electronic device 100 includes an antenna 131 configured to generate electrical signals in response to electromagnetic waves in the air. In an embodiment, the antenna 131 is configured to generate satellite navigation signals in response to electromagnetic waves emitted by satellites in a satellite navigation system. In an example, a global navigation satellite system (GNSS) includes multiple satellites (not shown) that provide a global coverage on the Earth. Each satellite transmits electromagnetic waves carrying ephemeris for the satellite, such as a code designated for the satellite. In an embodiment, the code can be used to determine a distance from the electronic device 100 to the satellite, and the distance is used in the coarse geo-fence detection.

Specifically, the navigation signal receiver 130 includes a receiving circuit 135, a range acquisition module 140 and a coarse geo-fence processing module 150. These elements are coupled together as shown in FIG. 1.

The receiving circuit 135 is coupled to the antenna 131 to receive an electrical signal generated in response electromagnetic waves in the air. The receiving circuit 135 includes suitable circuits to process the electrical signal and obtain a digital signal from the electrical signal. In an example, the receiving circuit 135 includes various analog circuits (not shown), such as amplifier, filter, down-converter and the like to process the electrical signal using analog processing techniques. In addition, the receiving circuit 135 includes an analog-to-digital converter (ADC) (not shown) that converts the processed analog signal to a digital signal. From the digital signal, a digital sequence, such as a binary sequence, can be obtained. In an example, the digital sequence includes codes designated for multiple satellites.

The range acquisition module 140 is configured to determine distances from the electronic device 100 to one or more satellites. In an embodiment, the range acquisition module 140 is configured to identify, from the digital sequence, codes designated for the satellites. In an example, a code designated for a satellite has a relatively large number of bits, such as about 720 gigabytes. For example, the code repeats once a week when the code is transmitted at 10.23 Mbit/s. Further, in an example, when the range acquisition module 140 receives a code designated for a satellite, the range acquisition module 140 determines a time the code taken from the satellite to the electronic device 100.

In an example, the electronic device 100 maintains a reference code based on a local clock at the electronic device 100. It is noted that the local clock at the electronic device 100 may be different from a clock used by a satellite due to clock drifting. The range acquisition module 140 compares the received code with the reference code maintained at the electronic device 100 to determine a number of bit shifts. In the example, based on the code transmission speed and the number of bit shifts, the range acquisition module 140 determines the time the code has taken from the satellite to the electronic device 100. Then, in an example, the range acquisition module 140 multiplies the speed of light by the time to obtain a distance from the satellite to the electronic device 100. In an example, the distance is referred to as pseudo-distance, the pseudo distance is different from the real distance between the satellite and the electronic device 100 due to for example, clock drifting, errors in the measurement, and the like.

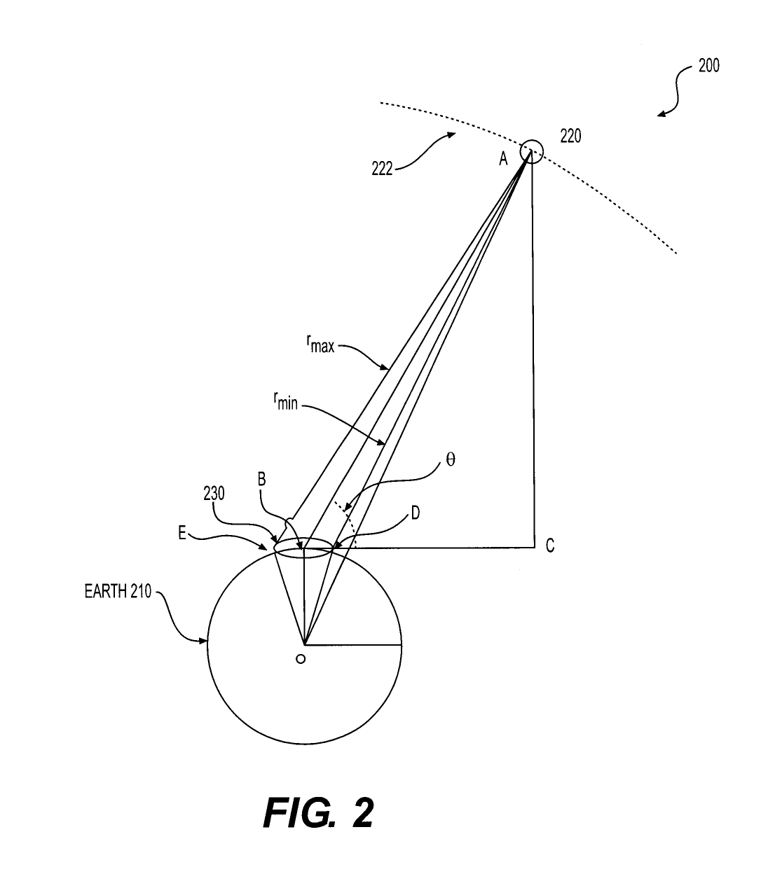

The coarse geo-fence processing module 150 includes suitable circuit to perform a coarse geo-fence detection that detects whether the electronic device 100 is inside a detection area or out of a detection area based on the pseudo-distance, a minimum distance from the detection area to the satellite and a maximum distance from the detection area to the satellite. In an embodiment, the coarse geo-fence detection does not need to determine the location of the electronic device 100 and does not need to perform PVT computation. The coarse geo-fence detection is described in detail with reference to FIG. 2.

In an embodiment, the navigation signal receiver 110 and the application processor 130 are implemented on different integrated circuit (IC) chips. In another embodiment, the navigation signal receiver 110 and the application processor 130 are implemented as two circuit blocks integrated on an IC chip.

FIG. 2 shows a plot 200 for illustrating a coarse geo-fence detection according to an embodiment of the disclosure. The coarse geo-fence detection is based on pseudo-distance and does not need to calculate accurate location.

The plot 200 shows Earth 210 as a circle, and the center of Earth 210 is shown as point O. The plot 200 shows a satellite 220 at point A of an orbit 222. Further, the plot 200 shows a circle 230 on the surface of Earth 210. The center of the circuit 230 is shown as point B. In an example, the area in the circle 230 is a detection area defined for a coarse geo-fence detection.

In FIG. 2, point C is a vertical projection of the satellite 220 on the plane of the circle 230, point D is a near cross point of line BC and the circle 230, and point E is a far cross point of line BC and the circle 230. The distance from the point D to the satellite 220 is the minimum distance (rₘᵢₙ) from the circle 230 to satellite 220, and the distance from the point E to the satellite 220 is the maximum distance (rₘₐₓ) from the circle 230 to the satellite. An angle θ between AB and BC has a value from 0 to πr/2. In an example, the angle θ, the minimum distance rₘᵢₙ and the maximum distance rₘₐₓ are calculated according to equations 1-3:

$$\begin{matrix}θ = {sin}^{- 1} ( \frac{{AB}^{2} + {BO}^{2} - {AO}^{2}}{2 AB \cdot BO} ) & ( 1 ) \\ {r}_{min} = \{ \begin{matrix}\sqrt{{AB}^{2} + {R}^{2} - 2 R \cdot AB \cdot cos θ} , & AB \cdot cos θ \geq R \\ AB \cdot sin θ , & AB \cdot cos θ < R\end{matrix} & ( 2 ) \\ {r}_{max} = \sqrt{{AB}^{2} + {R}^{2} + 2 R \cdot AB \cdot cos θ} & ( 3 )\end{matrix}$$

where AB denotes the distance between satellite 220 and the center B of the circle 230, BO denotes the distance between the center B of the circle 230 and the center O of Earth 210, AO denotes the distance between satellite 220 and the center O of Earth 210, and R denotes the radius of the circle 230.

It is noted that Earth 210 and the satellite 220 move relatively, and the minimum distance rₘᵢₙ and the maximum distance rₘₐₓ change over time. In an embodiment, at a first time t₀, the minimum distance rₘᵢₙ(t₀) and the maximum distance rₘₐₓ(t₀) are calculated, for example, based on PVT calculation, and at a second time t₁ later than the first time t₀ (e.g., one second to one minute later than the first time t₀), the minimum distance rₘᵢₙ(t₁) and the maximum distance rₘₐₓ(t₁) are calculated without PVT calculation, for example using equations 4 and 5:

$$\begin{matrix}{r}_{max} ( {t}_{1} ) = {r}_{max} ( {t}_{0} ) + {dr}_{max} \cdot ( {t}_{1} - {t}_{0} ) + \frac{1}{2} {ddr}_{max} \cdot {( {t}_{1} - {t}_{0} )}^{2} & ( 4 ) \\ {r}_{min} ( {t}_{1} ) = {r}_{min} ( {t}_{0} ) + {dr}_{min} \cdot ( {t}_{1} - {t}_{0} ) + \frac{1}{2} {ddr}_{min} \cdot {( {t}_{1} - {t}_{0} )}^{2} & ( 5 )\end{matrix}$$

where drₘₐₓ denotes a change speed of the maximum distance at the first time t₀, ddrₘₐₓ denotes a change acceleration of the maximum distance at the first time t₀, drₘᵢₙ denotes a change speed of the minimum distance at the first time t₀, and ddrₘᵢₙ denotes a change acceleration of the minimum distance at the first time t₀. The parameters drₘₐₓ, ddrₘₐₓ, drₘᵢₙ, and drₘᵢₙ can be calculated at the first time t₀, for example, based on PVT calculation.

According to an aspect of the disclosure, at the second time t₁, when the electronic device 100 is in the circle 230, the distance from the electronic device 100 to the satellite 220 is longer than the minimum distance and shorter than the maximum distance from the detection area to the satellite 220, such as shown in the inequality 6:

rₘᵢₙ(t₁)<r(t₁)<rₘₐₓ(t₁) (6)

where r(t₁) denotes the real distance from the electronic device 100 to the satellite 220.

Further, according to the aspect of the disclosure, the electronic device 100 is configured to calculate a pseudo-distance without PVT calculation at the second time t₁. In an example, the relationship of the pseudo-distance and the real distance can be expressed as shown in equation 7:

r(t₁)=ρ(t₁)−ρ_{clk}(t₁)−e(t₁) (7)

where ρ(t₁) denotes the pseudo-distance from the electronic device 100 to the satellite 220, ρ_{clk}(t₁) denotes the pseudo-distance bias caused by receiver local clock bias at the electronic device 100, e(t₁) is the pseudo-distance measurement error.

It is noted that, in an example, the electronic device 100 receives signals from multiple satellites (not shown). The electronic device 100 respectively performs similar calculations as for the satellite 220 respectively for the multiple satellites. In an embodiment, when, the electronic device 100 is inside the circle 230, for each satellite, the real distance from the electronic device 100 to the satellite is longer than the minimum distance between the circle 230 and the satellite, and is shorter than the maximum distance between the circle 230 and the satellite. However, for at least one satellite, when the real distance from the electronic device 100 to the satellite is shorter than the minimum distance between the circle 230 and the satellite, or when the real distance from the electronic device 100 to the satellite is longer than the maximum distance between the circle 230 and the satellite, the electronic device 100 is outside the circuit 230.

In another embodiment, the coarse geo-fence detection is based on overlapping of clock skew and overlapping of clock drift calculation. In an example, for each satellite j from which the electronic device 100 receives a satellite navigation signal, a minimum pseudo-distance bias and a maximum pseudo-distance bias caused by the local clock bias at the electronic device 100, are calculated, according to equations 8 and 9:

ρ_{clk}_{_{—}}ₘᵢₙ_{_{—}}ⱼ(t₁)=ρⱼ(t₁)−eⱼ(t₁)−rₘₐₓ_{_{—}}ⱼ(t₁) (8)

ρ_{clk}_{_{—}}ₘₐₓ_{_{—}}ⱼ(t₁)ρⱼ(t₁)−eⱼ(t₁)−rₘᵢₙ_{_{—}}ⱼ(t₁) (9)

where ρ_{clk}_{_{—}}ₘᵢₙ_{_{—}}ⱼ denotes the minimum pseudo-distance bias with respect to satellite j, ρ_{clk}_{_{—}}ₘₐₓ(t₁) denotes the maximum pseudo-distance bias with respect to satellite j, ρⱼ(t₁) denotes the pseudo-distance between the electronic device 100 and the satellite j, eⱼ(t₁) denotes the pseudo-distance measurement error with respect to satellite j, rₘᵢₙ_{_{—}}ⱼ(t₁) denotes the minimum distance between the circle 230 and the satellite j, and rₘₐₓ_{_{—}}ⱼ (t₁) denotes the maximum distance between the circle 230 and the satellite j. Further, the overlapping of clock skew (O_{skew}) is calculated according to equation 10:

O_{↓}skew= [symbol] min [symbol] _{↓}(all j)(ρ_{↓}(clk↓max [symbol] j)(t_{↓}1))− [symbol] max [symbol] _{↓}(all j)(ρ_{↓}(clk_{↓}min [symbol] j)(t_{↓}1)) (10)

It is noted that the overlapping of clock skew can be calculated without PVT calculation. In an example, the pseudo-distances between the electronic device 100 and the satellites are calculated by the range acquisition module 140 without PVT calculation, the minimum distances between the circle 230 and the satellites, and the maximum distances between the circle 230 and the satellites can be calculated based on equations 4 and 5 without PVT calculation, and the pseudo-distance measurement error can be cancelled out and does not need to be known. Thus, the overlapping of clock skew can be calculated without PVT calculation. When the overlapping of clock skew is equal to or larger than zero, the electronic device 100 is inside the circle 230; otherwise, the electronic device 100 is outside the circle 230.

Further, in an example, a minimum pseudo-distance shift and a maximum pseudo-distance shift caused by the local clock drift at the electronic device 100, are calculated, according to equations 11 and 12:

Δρ_{clk}_{_{—}}ₘᵢₙ_{_{—}}ⱼ(t₁)=Δρⱼ(t₁)−Δeⱼ(t₁)−[rₘₐₓ_{_{—}}ⱼ(t₁)−rⱼ(t₀)] (11)

Δρ_{clk}_{_{—}}ₘₐₓ_{_{—}}ⱼ(t₁)=Δρⱼ(t₁)−Δeⱼ(t₁)−[rₘᵢₙ_{_{—}}ⱼ(t₁)−rⱼ(t₀)] (12)

where Δρⱼ(t₁) denotes pseudo-distance change and is calculated as Δρⱼ(t₁)=ρⱼ(t₁)−ρⱼ(t₀), Δeⱼ(t₁) denotes the pseudo-distance measurement error change from time t₀ to t₁. Further, the overlapping of clock drift (O_{drift}) is calculated according to equation 13:

O_{↓}drift= [symbol] min [symbol] _{↓}(all j)( [symbol] Δρ [symbol] _{↓}(clk_{↓}max [symbol] j)(t_{↓}1))− [symbol] max [symbol] _{↓}(all j)( [symbol] Δρ [symbol] _{↓}(clk [symbol] min [symbol] j)(t_{↓}1)) (13)

It is noted that, similar to the overlapping of clock skew, the overlapping of clock drift can be calculated without PVT calculation. When the overlapping of clock drift is equal or larger than zero, the electronic device 100 is inside the circle 230; otherwise, the electronic device 100 is outside the circle 230.

The coarse geo-fence detection discussed with reference to FIG. 2 can be used in various applications to release the application processor 110 from too much PVT computation, such that the application processor 110 is more likely to enter the power save mode.

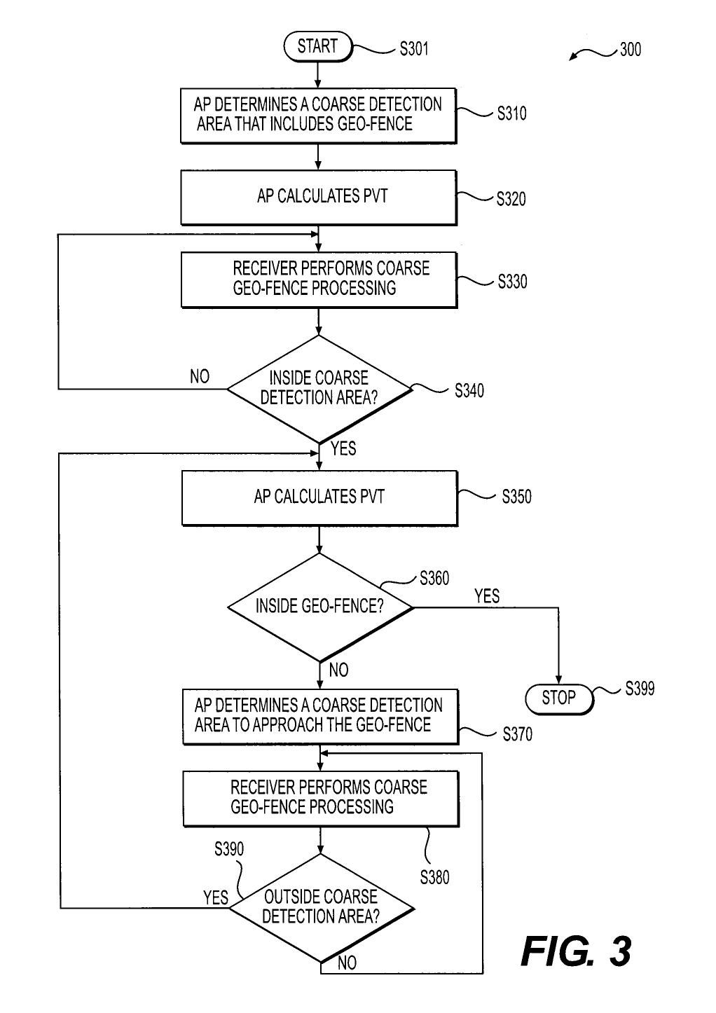

FIG. 3 shows a flow chart outlining a process 300 according to an embodiment of the disclosure. In an embodiment, a geo-fence detection based application is executed in the electronic device 100. Initially, the electronic device 100 is out of a geo-fence defined in the application, and the electronic device 100 executes the process 300 to detect a geo-fence event that the electronic device 100 enters the geo-fence. The process starts at S301 and proceeds to S310.

At S310, a coarse detection area that includes the geo-fence is determined. In an example, the application processor 110 executes software instructions of an application, for example stored in the memory 120. The application includes a pre-defined geo-fence. The geo-fence can have any suitable shape, such as a circle, a rectangle, and the like. The application processor 110 determines a coarse detection area that includes the geo-fence. In an embodiment, the coarse detection area is a circle.

At S320, a PVT calculation is performed. In an example, the navigation signal receiver 130 receives signals from GNSS, suitably processes the signals, and provides the processed signals to the application processor 110. The application processor 110 executes software instructions 125 to perform PVT computation based on the received signals from the GNSS. The application processor 110 calculates various parameters, such as minimum distances between the coarse detection area and the satellites in the GNSS, maximum distances between the coarse detection area and the satellites in the GNSS, the change speed of the minimum distances, the change speed of the maximum distances, the change acceleration of the minimum distances, the change acceleration of the maximum distances and the like. The calculated values can be used as initial values at an initial time in a coarse geo-fence detection, and calculated values are provided to the navigation signal receiver 130.

At S330, a coarse geo-fence processing is performed without PVT calculation. In an embodiment, the navigation signal receiver 130 receives signals from GNSS at a time later than the initial time, and processes the signals for the coarse geo-fence detection. For example, the range acquisition module 140 calculates pseudo-distances from the electronic device 100 to the satellites, and the navigation signal receiver 130 calculates the overlapping of clock skew as discussed with respect to FIG. 2. In another example, the navigation signal receiver 130 calculates the overlapping of clock drift as discussed with respect to FIG. 2.

At S340, the process proceeds based on a determination whether the electronic device 100 is inside the coarse detection area or outside the coarse detection area. In an example, when the overlapping of clock skew is equal to or larger than zero, the electronic device 100 is inside the coarse detection area; otherwise, the electronic device 100 is outside the coarse detection area. In another example, when the overlapping of the clock drift is equal to or larger than zero, the electronic device 100 is inside the coarse detection area; otherwise, the electronic device 100 is outside the coarse detection area. When the electronic device 100 is in the coarse detection area, the process proceeds to S350; otherwise, the process returns to S330.

At S350, a PVT calculation is performed to calculate accurate position. In an example, the navigation signal receiver 130 receives signals from GNSS, suitably processes the signals, and provides the processed signals to the application processor 110. The application processor 110 executes software instructions 125 to perform PVT computation, and determine the accurate location of the electronic device 100.

At S360, the process proceeds based on a determination whether the electronic device 100 is inside the geo-fence or not. In an example, the application processor 110 compares the accurate location of the electronic device 100 with the geo-fence defined in the application, and determines whether the electronic device 100 is inside the geo-fence or outside the geo-fence. When the electronic device 100 is outside the geo-fence, the process proceeds to S360. When the electronic device 100 is inside the geo-fence, the geo-event that the electronic device 100 enters the geo-fence is detected, and the electronic device 100 operates in response to the detected geo-fence event, and the process proceeds to S399 and terminates.

At S370, a coarse detection area to approach the geo-fence is determined. In an embodiment, the application processor 110 uses the location of the electronic device 100 as a center, and determines a circle to approach the geo-fence defined in the application. In an example, the application processor 110 determines the coarse detection area as a maximum circle that is out of the geo-fence and intersects with the geo-fence at a single point. Further, in an example, the application processor 110 calculates various parameters, such as minimum distances from the coarse detection area to the satellites in the GNSS, maximum distances from the coarse detection area to the satellites in the GNSS, the change speed of the minimum distances, the change speed of the maximum distances, the change acceleration of the minimum distances, the change acceleration of the maximum distances and the like. The calculated values can be used as initial values at an initial time in a next coarse geo-fence detection, and are provided to the navigation signal receiver 130.

At S380, a coarse geo-fence processing is performed without PVT calculation. In an embodiment, the navigation signal receiver 130 receives signals from GNSS at a time later than the initial time, and processes the signals for the coarse geo-fence detection. For example, the range acquisition module 140 calculates pseudo-distances from the electronic device 100 to the satellites, and the navigation signal receiver 130 calculates the overlapping of clock skew as discussed with respect to FIG. 2. In another example, the navigation signal receiver 130 calculates the overlapping of clock drift as discussed with respect to FIG. 2.

At S390, the process proceeds based on a determination whether the electronic device 100 is inside the coarse detection area or outside the coarse detection area. In an example, when the overlapping of clock skew is equal to or larger than zero, the electronic device 100 is inside the coarse detection area; otherwise, the electronic device 100 is outside the coarse detection area. In another example, when the overlapping of the clock drift is equal to or larger than zero, the electronic device 100 is inside the coarse detection area; otherwise, the electronic device 100 is outside the coarse detection area. When the electronic device 100 is outside the coarse detection area, the process returns to S350; and when the electronic device 100 is inside the coarse detection area, the process returns to S380.

In an embodiment, when the navigation signal receiver 130 repetitively performs the coarse geo-fence detection, the application processor 110 is idle and enters a power saving mode to save power.

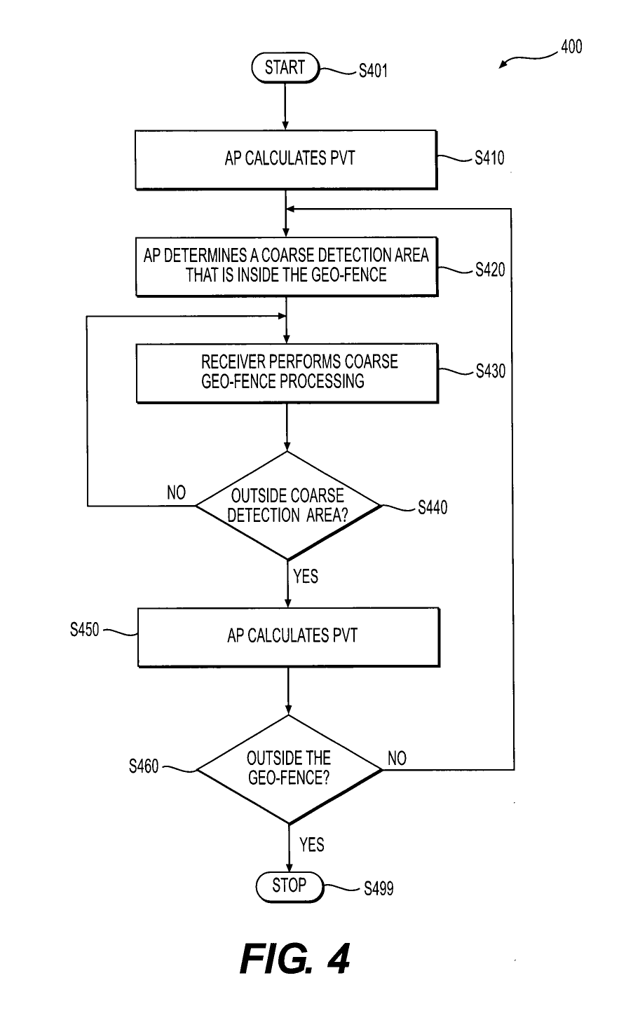

FIG. 4 shows a flow chart outlining a process 400 according to an embodiment of the disclosure. In an embodiment, a geo-fence detection based application is executed in the electronic device 100. Initially, the electronic device 100 is inside a geo-fence defined in the application, and the electronic device 100 executes the process 400 to detect a geo-fence event that the electronic device 100 exits the geo-fence. The process starts at S401 and proceeds to S410.

At S410, a PVT calculation is performed. In an example, the navigation signal receiver 130 receives signals from GNSS, suitable processes the signals, and provides the processed signals to the application processor 110. The application processor 110 executes software instructions 125 to perform PVT computation.

At S420, a coarse detection area that is inside the geo-fence is determined. In an embodiment, the application processor 110 uses the location of the electronic device 100 as center, and determines a circle inside the geo-fence. In an example, the application processor 110 determines a maximum circle that is inside of the geo-fence and intersects with the geo-fence at a single point to be the coarse detection area. Further, the application processor 110 calculates various parameters, such as minimum distances from the coarse detection area to the satellites in the GNSS, maximum distances from the coarse detection area to the satellites in the GNSS, the change speed of the minimum distances, the change speed of the maximum distances, the change acceleration of the minimum distances, the change acceleration of the maximum distances and the like. The calculated values can be used as initial values at an initial time in a coarse geo-fence detection, and are provided to the navigation signal receiver 130.

At S430, a coarse geo-fence processing is performed without PVT calculation. In an embodiment, the navigation signal receiver 130 receives signals from GNSS at a time later than the initial time, and processes the signals for the coarse geo-fence processing. For example, the range acquisition module 140 calculates pseudo-distances from the electronic device 100 to the satellites, and the navigation signal receiver 130 calculates the overlapping of clock skew as discussed with respect to FIG. 2. In another example, the navigation signal receiver 130 calculates the overlapping of clock drift as discussed with respect to FIG. 2.

At S440, the process proceeds based on a determination whether the electronic device 100 is outside the coarse detection area or inside the coarse detection area. In an example, when the overlapping of clock skew is equal to or larger than zero, the electronic device 100 is inside the coarse detection area; otherwise, the electronic device 100 is outside the coarse detection area. In another example, when the overlapping of the clock drift is equal to or larger than zero, the electronic device 100 is inside the coarse detection area; otherwise, the electronic device 100 is outside the coarse detection area. When the electronic device 100 is outside the coarse detection area, the process proceeds to S450; otherwise, the process returns to S430.

At S450, a PVT calculation is performed to calculate accurate position. In an example, the navigation signal receiver 130 receives signals from GNSS, suitably processes the signals, and provides the processed signals to the application processor 110. The application processor 110 executes software instructions 125 to perform PVT computation, and determine the accurate location of the electronic device 100.

At S460, the process proceeds based on a determination whether the electronic device 100 is inside the geo-fence or not. In an example, the application processor 110 compares the accurate location of the electronic device 100 with the geo-fence defined in the application, and determines whether the electronic device 100 is inside the geo-fence or outside the geo-fence. When the electronic device 100 is inside the geo-fence, the process returns to S420. When the electronic device 100 is outside the geo-fence, the geo-event that the electronic device 100 exits the geo-fence is detected, and the electronic device 100 operates in response to the detected geo-fence event, and the process proceeds to S499 and terminates.

In an embodiment, when the navigation signal receiver 130 repetitively performs the coarse geo-fence detection, the application processor 110 is idle and enters a power saving mode to save power.

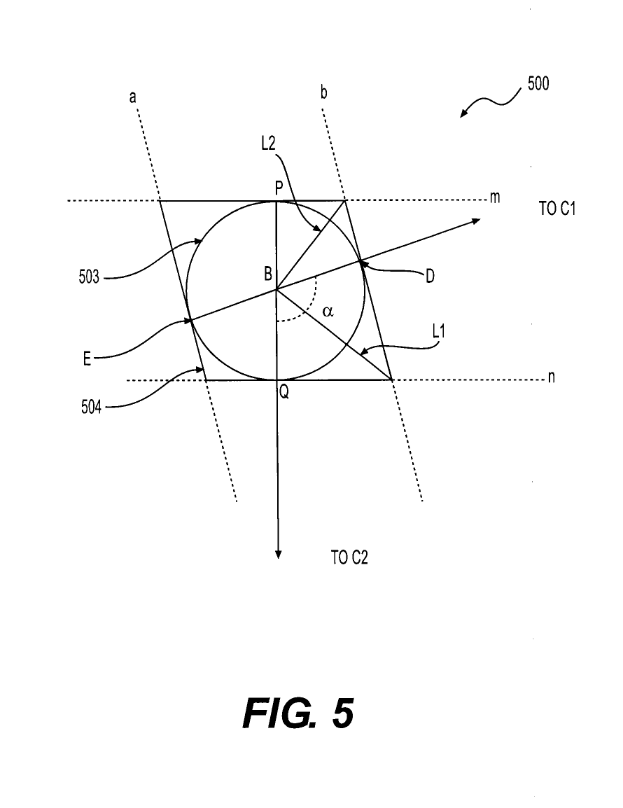

FIG. 5 shows a plot 500 for illustrating a method to determine a coarse detection area according to an embodiment of the disclosure. In an example, the method is used in S310 to determine a coarse detection area that includes a geo-fence.

The plot 500 shows a geo-fence 503. The geo-fence 503 is a circle with a center at point B. The radius of the geo-fence 503 is represented by R. C1 is a vertical projection point of a first satellite and C2 is a vertical projection point of a second satellite on the plane of the geo-fence 503. Further, point D is a near cross point of line BC1 and the circle 503, and point E is a far cross point of line BC1 and the circle 503. Inside the geo-fence 503, point E has a maximum distance to the first satellite, and point D has a minimum distance to the first satellite. An arc a is a segment of a first circle with the same distance as point E to the first satellite, and an arc b is a segment of a second circle with the same distance as point D to first satellite.

Similarly, inside the geo-fence 503, point P has a maximum distance to the second satellite, and point Q has a minimum distance to the second satellite. An arc m is a segment of a third circle with the same distance as point P to the second satellite, and an arc n is a segment of a fourth circle with the same distance as point Q to the second satellite. An angle α is the difference of the azimuth of first satellite and the second satellite.

According to an aspect of the disclosure, orbit height of the GNSS satellites are tens of thousands of kilometers, and generally, the radius R is much smaller than C1-D and C1-E. Thus, the arc a and the arc b are approximately parallel lines. Similarly, the arc m and the arc n are approximately parallel lines. Thus, the arc a, arc b, arc m and arc n form a diamond shape 504 that covers the geo-fence 503. In an example, L1 and L2 are half of the diagonal lines in the diamond shape 504, and can be calculated according to equations 14 and 15, and the maximum value of L1 and L2 is represented by L as shown in equation 16.

L1=R/cos(α/2) (14)

L2=R/sin(α/2) (15)

L=max(L1,L2) (16)

According to an aspect of the disclosure, a coarse detection area can be formed by a circle with point B as a center and L as a radius, and the coarse detection area fully covers the geo-fence 503. It is noted that when α approaches to 90 degree, L becomes smaller.

In an embodiment, when an electronic device, such as the electronic device 100 receives navigation signals from multiple satellites, the electronic device is configured to select two satellites from the multiple satellites. In an example, the difference angle of the two azimuths for the two satellites is close to 90 degree and the elevation of two satellites is not close to 90 degree. Then, based on the selected satellites, the electronic device calculates a radius L according to equations 14-16. The electronic device determines a circle as the coarse detection area, the center of the circle is the same as the geo-fence 503, and the radius of the circle is L.

While aspects of the present disclosure have been described in conjunction with the specific embodiments thereof that are proposed as examples, alternatives, modifications, and variations to the examples may be made. Accordingly, embodiments as set forth herein are intended to be illustrative and not limiting. There are changes that may be made without departing from the scope of the claims set forth below.

What is claimed is:

1. A circuit for geo-fence detection, comprising:
a receiving circuit configured to receive a satellite navigation signal from a satellite; and
a processing circuit configured to calculate a distance between the circuit and the satellite based on the satellite navigation signal, and determine whether the circuit is in a detection area based on the distance, a minimum distance from the detection area to the satellite and a maximum distance from the detection area to the satellite.

2. The circuit of claim 1, wherein the processing circuit is configured to determine whether the circuit is in a circular detection area based on the distance, the minimum distance from the circular detection area to the satellite and the maximum distance from the circular detection area to the satellite.

3. The circuit of claim 1, wherein the processing circuit is configured to adjust the minimum distance at a time based on a first distance between the satellite and a first location in the detection area at a previous time, a first speed of change for the first distance at the previous time and a first acceleration of change for the first distance at the previous time, and adjust the maximum distance at the time based on a second distance between the satellite and a second location in the detection area at the previous time, a second speed of change for the second distance at the previous time and a second acceleration of change for the second distance at the previous time.

4. The circuit of claim 3, wherein the processing circuit is configured to receive the first distance, the first speed, the first acceleration, the second distance, the second speed and the second acceleration that are calculated by another circuit using position, velocity, time (PVT) computation.

5. The circuit of claim 1, wherein the processing circuit is configured to determine whether the circuit is in the detection area without calculating a location of the circuit.

6. The circuit of claim 1, wherein
the processing circuit is configured to detect an event that the circuit enters/exits the detection area, and inform another circuit to cause the other circuit to calculate a location of the circuit to confirm or deny the event.

7. The circuit of claim 1, wherein
the receiving circuit is configured to receive satellite navigation signals from a plurality of satellites; and
the processing circuit is configured to calculate an overlap of clock bias and/or an overlap of clock drift that is a function of distances between the circuit and the plurality of satellites, minimum distances from the detection area to the plurality of satellites and maximum distances from the detection area to the plurality of satellite, and determine whether the circuit is inside the detection area based on the overlap of clock bias and/or the overlap of clock drift.

8. A method for geo-fence detection, comprising:
receiving, at a circuit, a satellite navigation signal from a satellite;
calculating a distance between the circuit and the satellite based on the satellite navigation signal; and
determining whether the circuit is in a detection area based on the distance, a minimum distance from the detection area to the satellite and a maximum distance from the detection area to the satellite.

9. The method of claim 8, wherein determining whether the circuit is in the detection area based on the distance, the minimum distance from the detection area to the satellite and the maximum distance from the detection area to the satellite further comprises:
determining whether the circuit is in a circular detection area based on the distance, the minimum distance from the circular detection area to the satellite and the maximum distance from the circular detection area to the satellite.

10. The method of claim 8, further comprising:
adjusting the minimum distance at a time based on a first distance between the satellite and a first location in the detection area at a previous time, a first speed of change for the first distance at the previous time and a first acceleration of change for the first distance at the previous time; and
adjusting the maximum distance at the time based on a second distance between the satellite and a second location in the detection area at the previous time, a second speed of change for the second distance at the previous time and a second acceleration of change for the second distance at the previous time.

11. The method of claim 10, further comprising:
performing position, velocity, time (PVT) calculation at the previous time to determine the first distance, the first speed, the first acceleration, the second distance, the second speed and the second acceleration.

12. The method of claim 8, wherein determining whether the circuit is in the detection area based on the distance, the minimum distance from the detection area to the satellite and the maximum distance from the detection area to the satellite further comprises:
determining whether the circuit is in the detection area without calculating a location of the circuit.

13. The method of claim 8, further comprising:
detecting an event that the circuit enters/exits the detection area based on the distance, the minimum distance from the detection area to the satellite and the maximum distance from the detection area to the satellite;
calculating a location of the circuit; and
confirming/denying the event based on the location.

14. The method of claim 8, wherein
receiving, at the circuit, satellite navigation signals from a plurality of satellites;
calculating an overlap of clock bias and/or an overlap of clock drift that is a function of distances between the circuit and the plurality of satellites, minimum distances from the detection area to the plurality of satellites and maximum distances from the detection area to the plurality of satellite; and
determining whether the circuit is inside the detection area based on the overlap of clock bias and/or the overlap of clock drift.

15. An apparatus, comprising:
a navigation signal receiver that comprises:
a receiving circuit configured to receive a satellite navigation signal from a satellite; and
a processing circuit configured to calculate a distance between the apparatus and the satellite based on the satellite navigation signal, and determine whether the apparatus is in a detection area based on the distance, a minimum distance from the detection area to the satellite and a maximum distance from the detection area to the satellite.

16. The apparatus of claim 15, wherein the processing circuit is configured to determine whether the apparatus is in a circular detection area based on the distance, the minimum distance from the circular detection area to the satellite and the maximum distance from the circular detection area to the satellite.

17. The apparatus of claim 15, wherein the processing circuit is configured to adjust the minimum distance at a time based on a first distance between the satellite and a first location in the detection area at a previous time, a first speed of change for the first distance at the previous time and a first acceleration of change for the first distance at the previous time, and adjust the maximum distance at the time based on a second distance between the satellite and a second location in the detection area at the previous time, a second speed of change for the second distance at the previous time and a second acceleration of change for the second distance at the previous time.

18. The apparatus of claim 17, further comprising:
a processor configured to perform position, velocity and time (PVT) computation to calculate the first distance, the first speed, the first acceleration, the second distance, the second speed and the second acceleration.

19. The apparatus of claim 18, wherein
the processing circuit is configured to detect an event that the circuit enters/exits the detection area; and
the processor is configured to calculate a location of the apparatus to confirm or deny the event.

20. The apparatus of claim 15, wherein
the receiving circuit is configured to receive satellite navigation signals from a plurality of satellites; and
the processing circuit is configured to calculate an overlap of clock bias and/or an overlap of clock drift that is a function of distances between the circuit and the plurality of satellites, minimum distances from the detection area to the plurality of satellites and maximum distances from the detection area to the plurality of satellite, and determine whether the circuit is inside the detection area based on the overlap of clock bias and/or the overlap of clock drift.
